(19) United States
(12) Patent Application Publication
(10) Pub. No.: US 2007/0066175 A1
(43) Pub. Date: Mar. 22, 2007

(54) PROTECTIVE FLAME BARRIER PRODUCT

(76) Inventors: Stephen Wolf, Morristown, TN (US); Kenneth R. Oliver, Collierville, TN (US)

Correspondence Address: W. EDWARD RAMAGE, COMMERCE CENTER SUITE 1000, 211 COMMERCE ST, NASHVILLE, TN, 37201, US

(21) Appl. No.: 11/533,452

(22) Filed: Sep. 20, 2006

Related U.S. Application Data
(60) Provisional application No. 60/718,718, filed on Sep. 20, 2005.

(51) Int. Cl. D04H 1/00; B32B 5/26; D03D 15/00

(52) U.S. Cl. 442/415; 428/920; 428/921; 442/301; 442/302; 442/414; 442/381

(57) ABSTRACT

A flame barrier product for use in mattresses, foundations, and upholstered furniture with one or more layers of fibers. A first component scavenges oxygen from a burn site. A second component burns to form an insulating char. The first component may comprise at least one category 2 fiber, which may comprise modacrylic. In one embodiment, the second component is a batting comprising at least one category 4 fiber, which may be cotton. The first component may be treated with a flame-retardant coating. Flame barrier products of the present invention may comprise highloft batting or densified batting. Where cotton is used, it may be treated with flame retardant chemicals, such as boric acid. A method of constructing the invention also is disclosed.

This application claims priority to Provisional Patent Application No. 60/718,718, filed Sep. 20, 2005, by Steven Wolf, et al., and is entitled in whole or in part to that filing date for priority. The specification, drawings, and attachments of Provisional Patent Application No. 60/718,718 are incorporated herein in their entirety by reference.

### FIELD OF THE INVENTION

This invention relates to combinations for use in forming fire-resistant upholstered products such as mattresses, foundations such as boxsprings and other mattress support systems, and upholstered furniture.

### BACKGROUND OF THE INVENTION

In the 1970s, the United States and other countries established flammability standards for mattresses and upholstered furniture because fires initiated by burning cigarettes were a major concern. Prior to that, upholstery fabrics and mattress ticking were predominantly made of natural fibers such as cotton, rayon, and linen. These materials are prone to smolder and their use, in combination with careless cigarette use, is thought to have caused thousands of deaths each year until the new flammability standard was established.

In response to the need to develop smolder-resistant materials, man-made materials, predominantly thermoplastics, were developed. Unfortunately, many of these materials, while smolder-resistant, are more prone to be ignited by open flame. When they do burn, they may also burn more rapidly and with more intensity than do the natural cellulosic materials (linen, cotton, etc.). Residential fires that start in the bedroom are often caused by children playing with lighters, matches, or candles. The United States Consumer Product Safety Commission estimates than in 1998 alone there were over 390 deaths and more than two hundred million dollars in property damage attributable to these fires.

The United States National Institute of Standards and Technology (NIST) has established test parameters for testing mattress and box spring combinations to determine their resistance to ignition by an open flame (“Protocol for Testing Mattress/Foundation Sets Using a Pair of Gas Burners”). The California Bureau of Home Furnishings has also published such a test in Technical Bulletin 603. The British government has established an open flame standard (BS 7177: “Specification for Resistance to Ignition of Mattresses, Divans, and Bed Bases”), which has been adopted as the European standard (EN 597-2), and other governments, trade associations, and independent certification laboratories have also addressed the importance of developing more flame-resistant bedding by establishing their own standards and testing.

A number of companies have been developing fire-resistant and flame-retardant compositions to decrease open-flame ignition of bedding and bed clothes. Fire-resistant textile fibers such as glass, Nomex®, and Kevlar® are used, as are double-core spun yarns and neoprene (polychloroprene) and polyurethane foam. Cotton batting is treated with boric acid, or may be densified to mechanically interlock the fibers for added strength. High-loft battings have been produced from melamine fiber blends or carbon fiber blends. Flame-retardant chemical coatings are applied, either as a backcoating to the cover fabric or to the surface of the first layer of the cushioning materials. Cotton and fiberglass, as well as coated woven fiberglass, may also be used in bedding materials. Pre-oxidized carbon fiber has been incorporated into bedding materials, and some use thermally bonded cotton fiber-based products with a low percentage of low-melt fibers.

Some of these combinations are the subject of issued patents or patent applications, such as U.S. Pat. No. 6,287,690 (Land, Fire Resistant Corespun Yarn and Fabric Comprising Same); U.S. Pat. No. 4,504,991 (Klancnik, Fire-Resistant Mattress and High Strength Fire-Retardant Composite); and WO 03/023108 (Mater, Nonwoven Highloft Flame Barrier). U.S. Pat. No. 3,670,348 (Irwin) discloses the use of a fiberglass pad inside the ticking to enclose the flammable layers of a mattress or foundation. Since fiberglass fibers tend to break, however, the mattress can become “itchy,” and not as soft as more traditionally made mattresses. U.S. Pat. No. 3,818,521 (Richards) discloses the use of a heat conducting metallic foil between the ticking and padding layers, meant to transfer heat when it is applied to a small area of the mattress, such as when the mattress is contacted by open flame or cigarette.

Some of the materials and combinations mentioned above are highly effective, while some are not. Those that are effective are often expensive, limiting their use. Finding an effective combination that is also cost-effective has been a challenge. To complicate things further, the effectiveness of combinations of products has not been predictable, since “fire researchers have demonstrated that materials exhibiting good fire performance when tested as isolated components sometimes perform less well when tested in a composite structure with other components. On occasion it has been found that the fire performance of a composite assembly of certain components is worse than the fire performance of any of the individual components.” (Damant, G. “Flammability: Achieving Compliance,” BEDtimes, Sleep Products Safety Council, September 2002, p. 33.)

In spite of the development of numerous fire-resistant and fire-retardant products, the mattress and upholstered furniture industries still need a cost-effective, safer, more fire-resistant bedding product that will comply with standards for open-flame testing such as those found in California Technical Bulletin 603.

### SUMMARY OF THE INVENTION

The present invention provides flame barrier products for use in mattresses, foundations, and upholstered furniture comprising a first component which scavenges oxygen from a burn site and a second component which burns to form an insulating char. In one embodiment of the invention, the first component comprises at least one category 2 fiber, which may comprise modacrylic.

In another embodiment, the first component of a flame barrier product as described by the present invention comprises a flame-retardant coating.

In another embodiment of the invention, a flame barrier product comprises a first component which scavenges oxygen from a burn site and a second component which is a batting comprising at least one category 4 fiber, which may be cotton.

Flame barrier products of the present invention may comprise highloft batting or densified batting. Where cotton is used, it may be treated with flame retardant chemicals, such as boric acid.

### BRIEF DESCRIPTION OF THE DRAWINGS

FIG. 1 is a cross-sectional view of one composite layer constructed in accordance with one embodiment of the present invention.

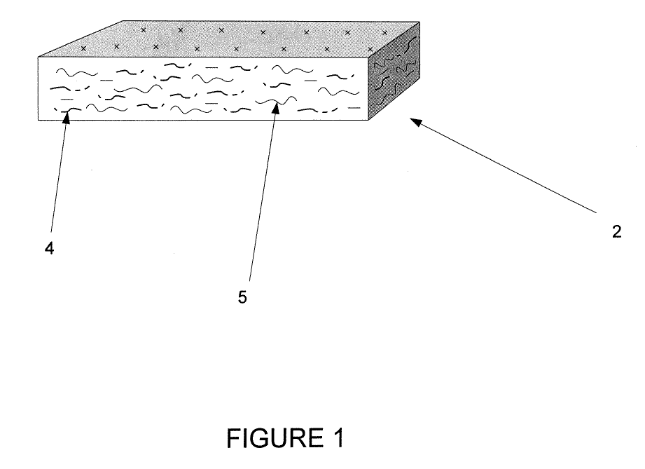

FIG. 2 is a cross-sectional view of two composite layers constructed in accordance with one embodiment of the present invention.

FIG. 3 is a perspective view with a partial cut-away section of a mattress constructed in accordance with one embodiment of the present invention.

FIG. 4 shows a sequence of steps in the method used to produce one embodiment of the invention.

### DETAILED DESCRIPTION OF VARIOUS EMBODIMENTS OF THE INVENTION

While some fire-resistant fiber combinations have focused on the use of inherently flame-retardant fibers such as melamine (Basofil®, BASF A.G.), the inventors have discovered a non-woven flame barrier composition 2 comprised of a blend of fibers, suited for use in mattresses, foundations, upholstered furniture and fiber-filled bed clothing, that provides the fire-retardant properties necessary to meet the more stringent open-flame test standards while being less costly than melamine and similar fire-resistant fibers. The fiber blend of the present invention can be used to manufacture an upholstered furniture product, particularly a bedding product such as a mattress 10, that is resistant to ignition by open flame while being produced without a significant increase in production cost. The flame barrier 2 is intended for use beneath the cover 12 of an upholstered product, such as a mattress 10, or beneath the cover 12 and first padding layer 14 of such product. The cover 12 is relatively thin and therefore does not provide significant fuel for a fire, but will also not provide a sufficient heat barrier to protect the layers of padding underneath.

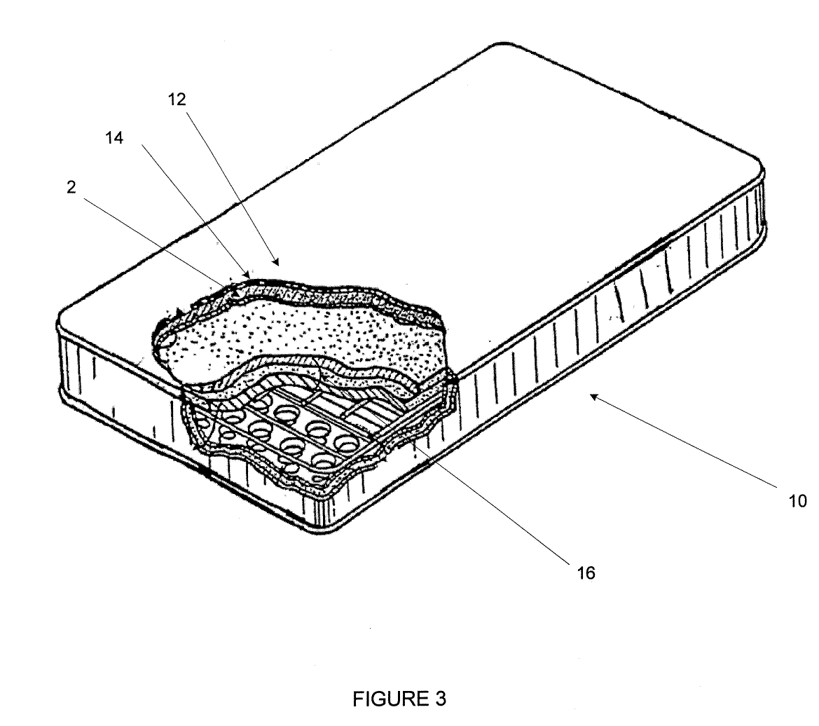

As seen in FIG. 3, mattresses 10 can be used alone, or in combination with a foundation. “Foundation,” as used herein, means any supporting system under the mattress, including, for example, boxsprings utilizing metal springs and wooden foundations without springs. A non-fire resistant padding layer (the “sacrificial layer”) 14 may also be used in one embodiment of the invention between the flame barrier and cover fabric in certain constructions. As used herein, “sacrificial layer” refers to a layer, often made of polyester, that is normally thin and provides enhanced feel and comfort for some portions of mattress lineups. As used in one embodiment of the present invention, a sacrificial layer 14 would be positioned between the flame barrier product 2 of the present invention and the cover fabric 12. Because the sacrificial layer 14 is thin and usually burns away, it does not provide enough fuel to cause a failure of the flame barrier 2 beneath it.

The flame barrier product 2 comprises a first component 4 that removes free radicals (H⁺ and OH⁻) or depletes oxygen from a burn site to quench the fire, and a second component 5 that forms a char of sufficient strength to protect the more flammable layers of fibers beneath the flame barrier in an upholstered product, such as a mattress, from combustion by open flame, as indicated by open flame tests such as those described in California TB 603, available from the California Bureau of Home Furnishings. As one example of a composition as described by the present invention, a blend of fibers can be blended together to form a non-woven flame barrier 2 using modacrylic fibers, which deplete oxygen from a burn site and enhance charring of cellulosic fibers, such as cotton. To the modacrylic fibers can be added cotton fibers, which form a char layer at the burn site and, by forming the char, protect the underlying layers of more flammable fibers. The cotton can be treated by the addition of boric acid or other fire resistant chemicals to make it more flame-resistant, and can be supplemented with low-melt fibers to add strength. The cotton fibers can also be densified, through methods known to and regularly used by those of skill in the art of making fiber products, to provide added strength. The combination described by the present invention quenches the flame while forming a char of sufficient strength to protect the underlying fiber layers, minimizing the tendency of the flame barrier layer to shrink away from the flame, leaving holes that expose the underlying fibers and fiber blends. Modacrylic fibers promote a free radical capture process, forming oxyhalides (the halides being in the form of chloride molecules) on combustion at a temperature of over 600° F. The oxyhalides act as “free radical traps,” creating an endothermic reaction that draws heat away from the substrate. Modacrylic also acts as a dehydrating agent that enhances charring, particularly when it is blended with cellulosic fibers, such as cotton. The combination of these elements induces formation of a charring layer and hinders or extinguishes the burn by emitting oxygen-depleting gases. When strong fibers such as, for example, Kevlar®, Nomex® and/or Basofil® are added to the composite, the stronger fibers allow the charred cotton fibers to remain in place without collapsing. These fibers are inherently fire-resistant and resistant to shrinkage when exposed to direct flame. This type of fiber generally does not burn well, forms a significant char, and is able to retain strength when heated over a period of time. This is important, as it inhibits formation of a hole, crack, or breach in the barrier material that could allow the fire to proceed to lower layers 16 of the mattress 10 or other furniture product.

The invention can also be formed of additional fibers from polymers made with halogenated monomers which generate oxygen-depleting gases when exposed to flame temperatures, natural cellulosic fibers (either treated for fire resistance or untreated), and other synthetic fibers. Fibers from monomers that generate oxygen-depleting gases prevent ignition of underlying non-fire resistant materials, which tend to ignite easily and burn rapidly and intensely. To enhance formation of a stronger char, natural fibers such as cotton can be used. These fibers burn slowly when used in an untreated form and resist burning when additionally treated for fire resistance. These fibers tend to char in place, form an insulating layer, and burn very slowly, if at all. If synthetic fibers are used, they should be chosen from among those that do not easily shrink from a flame or burn rapidly. These fibers provide additional comfort when included in the flame barrier 2. Synthetic fibers may also be used which are themselves fire-resistant, although not likely to retain significant strength when heated or to release oxygen-depleting gases. These synergistic blends are able to withstand exposure to open flame and smoldering ignition sources for extended periods of time and to protect non-flame resistant cushioning materials 16 placed beneath the flame barrier 2 formed of the fiber blend from burning rapidly.

The product described by this invention has been demonstrated to meet the requirements proposed in California Technical Bulletin (TB) 603 (“Mattress open flame to include residential use”), California TB 604 (“Bed clothing open flame to include residential use”), and the requirements found in California TB 129 (“Mattress open flame for public occupancies”), California TB 133 (“Upholstered furniture open flame for public occupancies”), British standard 5852 (“Crib 5”), Federal Standard for smoldering cigarettes on mattress (16 CFR 1632), California TB 117, California TB 121 and Boston Fire Department Test IX-II for mattress combinations.

Fire resistant cotton batting, when provided in a properly-constructed mattress, is sufficiently fire-resistant to enable many mattresses to pass open flame test methods such as California's Technical Bulletin (TB) 129 (“Flammability Test Procedure for Mattresses for Use in Public Buildings”). In February 2003, however, the State of California published TB 603 (“Requirements and Test Procedure for Resistance of a Residential Mattress/Box Spring Set to Large Open-Flame”). Synergies between mattress ticking (cover fabrics) 12 and items beneath the cover fabrics in the area between the mattress and foundation enable prolonged burning in this area. If the burn continues in this area for a sufficient time, the flame will burn or char through the cotton-only flame barrier and ignite non-fire resistant filling materials inside the mattress or foundation, resulting in a test failure. A category 2 fiber, modacrylic fiber, is added to the cotton batting to produce a product that resists challenge by open flame at the mattress/foundation junction. Cotton batting (which is primarily cotton, but may also include some synthetic or other natural fibers), properly treated with boric acid or other fire resistant chemicals, produces a flame barrier product that resists ignition from both open flame and smoldering ignition sources. These treated cotton padding products may be non-bonded, mechanically bonded, or thermally bonded and may contain up to 60% synthetic fibers.

Category 1 fibers are “inherently flame-retardant” fibers such as melamines, meta-aramids, para-aramids, novoloids, flame retardant viscose rayons, etc. This category of fiber generally will not burn under extreme heat and retains a significant degree of fiber strength when exposed to extreme heat or open flame. Category 1 fibers include, for example, Basofil®, Twaron®, Kevlar®, Nomex®, Kynol® and Visil®. Para-aramid and certain other fibers of category 1 are also char formers, and therefore may be utilized for this property, as well.

Category 2 includes those fibers produced (e.g., extruded) from polymers made with halogenated monomers which generate oxygen-depleting gases that help to prevent decomposition and auto-ignition of underlying or adjacent materials such as polyurethane foam. Depletion of oxygen helps to self-extinguish the fire. These fibers may not retain their strength and may shrink under heat. Category 2 fibers include modacrylic, defined as a “manufactured fiber in which the fiber-forming substance is any long chain synthetic polymer composed of less than 85 percent but at least 35 percent by weight of acrylonitrile units.”(16 CFR §303.7, Rules and Regulations Under the U. S. Textile Products Identification Act.) PBX, Protex®, and Teflon® are also Category 2 fibers.

Category 3 fibers include low melt binder fibers or resins. This category of material is used to impart desirable physical properties to non-woven products, including increased product strength for handling purposes, as well as increased stability, durability, and resilience. These products are normally heat-set, and a chemical reaction is used to achieve bonding. Low melt binder fibers include single filament fibers or bi-component fibers and normally consist of combinations of polyesters, polyethylenes, polypropylenes, or mixtures thereof. Resins include halogenated binder resins based on vinyl chloride and ethylene vinyl chloride, as well as other types of resins.

Category 4 fibers include natural fibers, such as cotton, wool, silk and flax, for example. Natural fibers may be untreated or treated to increase fire resistance, as cotton, for example, is treated with boric acid or other fire resistant chemicals.

Category 5 fibers include non-flame retardant synthetic fibers such as; nylons, polyesters, polyolefins, rayons, acrylics, and other synthetic fiber combinations. The category also includes flame-retardant synthetic fibers that do not retain significant strength when heated and do not release oxygen depleting gases.

Enhanced performance during open flame testing has been achieved in the present invention by the combination of category 1, 2 3, 4 and/or 5 fibers to provide a barrier that can both deplete free radicals or oxygen to extinguish flame and form a char of sufficient strength to protect underlying layers of an upholstered product from igniting. Densifying these products provides superior results in some applications, such as the border application of a mattress or foundation. Specifically, densifying the fiber blend or using category 1 or category 3 fibers to supplement the fiber blend provides strength that maintains structural integrity during the burn to minimize breach of the flame barrier and inhibit formation of a hole, crack, or breach in the char layer, thereby protecting against ignition of the more flammable materials beneath the barrier when the mattress, foundation, or furniture product is exposed to flame. Addition of category 2 fibers slows the propagation of the burn and ultimately aids in self-extinguishing the burn. These techniques have been demonstrated to provide excellent results during full scale burn tests where the flame has been applied to areas that are more susceptible to open-flame ignition, such as the area between a foundation and mattress. Use of Category 2 fibers in conjunction with cotton fibers, maximizes the effectiveness of the flame barrier in washable upholstered furniture and bedding products, including comforters and bedspreads, in which boric acid treatment of the cotton is not desired.

Although a non-woven, densified cotton batting has been demonstrated to be effective to meet the open-flame standard of California TB 603, it is also a feature of the present invention that non-woven highloft batting may be used to achieve a similar result. Briefly, the term “highloft” is used in reference to (1) lofty, relatively low density non-woven fiber structures, preferable having a greater volume of air than fiber, (2) non-woven materials that are produced with the purpose of building loft or thickness without increasing weight, or (3) non-woven fiber products that are not densified or purposely compressed over a significant portion of the product in the manufacturing process. The highloft non-woven material typically has a thickness falling generally within a range of about 6 mm to about 75 mm.

A non-highloft non-woven product is one which has been purposefully densified or compressed over a significant portion of the product in order to decrease thickness or impart strength to the product. A non-highloft product may be processed through compression, with or without heat, or by calendaring, mechanical needling (which causes the fibers to be mechanically interlocked), hydro-entanglement, stitch bonding, or other densifying means known to those of skill in the art of fiber processing. The non-highloft non-woven material generally has a thickness falling within a range of about 1 mm to about 15 mm. The basis weight of either highloft or non-highloft non-wovens may be between about 75 gm/sq. meters to about 1200 gm./sq. m.

Additionally, fibers and fiber blends that have been coated with fire-retardant coatings may be used to provide the oxygen depleting and free-radical scavenging properties necessary to the present invention. These coatings may be provided as backcoating to a cover fabric 12 or as surface coating for the first layer of cushioning material 14. Flame retardant compositions include, for example, bromine-based compounds, phosphorus-based compounds, aluminum trihydrate (ATH), magnesium hydroxide (MDH), boron compounds such as zinc borates, zinc, tin, zinc hydroxystannate, silica products, aluminosilicate clays, graphite, and chloroparaffins (especially short chain chloroparaffins). These and other fire-retardant compositions are known to those of skill in the art of textile production. Intumescent chemicals may also be used in the present invention. Intumescent chemicals are fire resistant and can expand when heated to up to 1000 times their original size. Once expanded, they can act as a thermal barrier, gas flow barrier and liquid flow barrier.

Upon direct exposure to flame and smoldering ignition sources, the flame barrier 2 of the present invention forms a thick, flexible char barrier that exhibits thermally insulating properties to protect the layers 16 beneath the flame barrier. This thick flexible char also helps block and deplete the flow of oxygen and volatile decomposition gases, while providing structural integrity to the barrier material itself. This combination of properties results in an effective flame blocking barrier to protect other flammable materials from becoming involved in the fire or prolonging the time that it takes for the fire to ignite flammable materials.

Manufacturing of non-woven textile products is described in “Non-Woven Textile Fabrics,” Kirk-Othmer Encyclopedia of Chemical Technology, 3rd Ed., Vol. 16, p. 72-124, as well as other treatises, articles, and manuals familiar to those of skill in the art of textile manufacture. Manufacturing of the flame barrier of the present invention can include chemical, thermal, mechanical bonding, or no additional bonding after web formation of a non-woven flame barrier product. For non-highloft products, a densifying step, which can be accomplished by, for example, compression (with or without heat), calendaring, mechanical needling, hydro-entanglement, stitch bonding, or other densifying means, is performed after web formation.

In chemical bonding, a resin or adhesive, typically in latex form, is sprayed on the carded web and then dried, cured, or both dried and cured to bind the fibers together. Saturation bonding is done in a similar fashion, except that the web is immersed into a bath of resin instead of the resin being applied by spray.

Thermal bonding utilizes heat-sensitive resins or binder fibers. Heat sensitive resins can be applied in solid form and when heated, melt and flow to the intersection of individual fiber strands. When the product is cooled, the melted resins solidify, forming bonds or “glue” joints where fibers intersect. Heat sensitive binder fibers contain polymers that melt at relatively low temperatures. As with heat sensitive resins, when heated, these polymers melt and flow to the intersection of individual fiber strands. When the product is cooled, the melted polymers solidify, forming bonds or “glue” joints where fibers intersect. Binder fibers may be monofilament fiber strands with a significantly lower melting point than the fill fibers in the blend. The binder fiber may also be a bicomponent sheath-core fiber whereas the sheath component is a polymer of low melting point with the core being a polymer of a relatively high melting point. The bonds that are formed allow the fiber to remain in the orientation in which they were initially processed.

Non-bonded materials may also form the flame barrier 2 of the present invention. Non-bonded non-wovens are commonly referred to in the art as “soft goods”. Without bonding, the material will retain sufficient strength by way of natural entanglement brought about by the highloft-manufacturing web forming process, including, for example, carding, garnetting and mechanical compression.

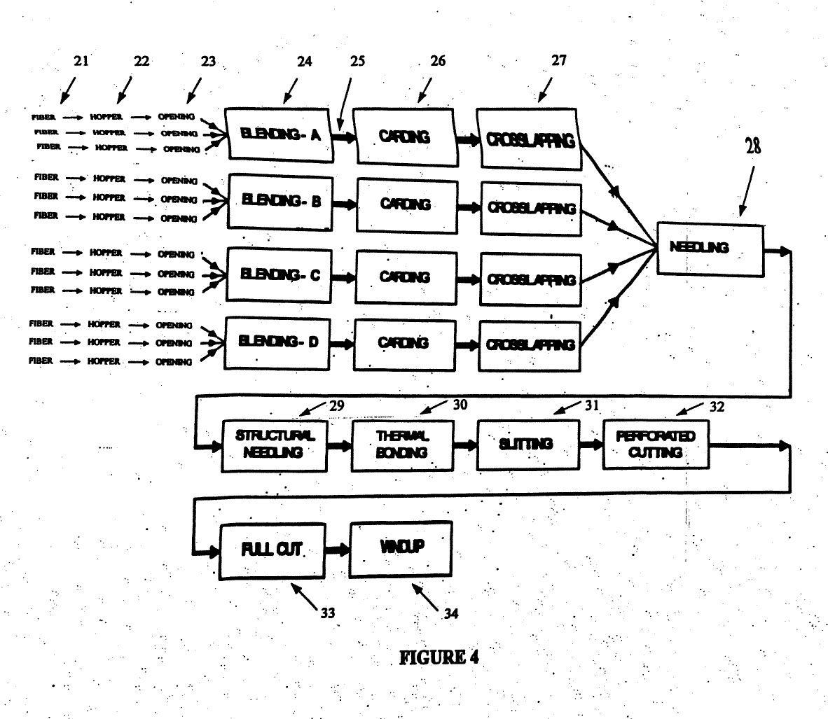

To manufacture the flame barrier product of the present invention, in accordance with one exemplary embodiment of the present invention as seen in FIG. 4, fiber 21 from compressed bales is placed first into hoppers 22 or onto a conveyor or other feeder device, where openers such as bale openers and/or fine openers 23 (Wise Industries, Kings Mountain, N.C.) begin to open the fiber bales or clumps and prepare the fibers for processing. Next, in the blending phase, the fibers are blended using multiple blending feeders 24, with different or like kinds of fiber, that weigh out specific amounts of fiber in order to achieve a precise “blend level” of various fibers. The precise blend level is achieved through electronically controlled weighing devices or through other forms of precise metering that provide for sufficient accuracy of the blend. The fiber is then collected on a common conveyor or air transport system 25 where the fiber is moved to the next processing stage or optionally moved to a mixing chamber and/or additional opener. Chemical additives, such as fire-retardant chemicals, may optionally be added in the mixing chamber, opening device or air transport system. Other types of chemicals may also be added to enable processing of the fiber for its intended use as a mattress flame barrier, upholstered furniture flame barrier, etc.

Once opened and blended, garnetts, cards 26, airlaying machines or volumetric chute-type machines form a fiber web or mat of fibers from the blend. The use of garnetts or cards may be followed by cross lappers 27, which lay the material on a conveyor and allow the fibers to be layered in height to provide for the proper weight basis of the mat of fibers and the desired width of the finished product. The use of airlay machines or volumetric chute type devices may be used and generally form a mat of fibers, which can be fed directly to the next process without the use of cross lappers. Other web forming machines may also be used such as the “Struto” process where webs of fibers are formed and arranged in specific orientations for desired end product characteristics. These web formation processes may be used alone, or in any desired combination to achieve a mat of fibers of appropriate properties for use in a specific type of upholstered furniture product.

For non-bonded soft products, the mat of fibers may also be optionally processed further by one or any combination of the following steps: passing through a set of compression rolls, sewing to a backing material (known as “stitched pads” to those of skill in the art), needling by a needle loom 28, stitched bonding 29, or hydroentangling. The non-bonded mat of fibers, in any of these forms, can be slit to the desired width 31, cut to the desired length 32, 33 and packaged for shipment 34.

For highloft bonded products, the mat of fibers passes through thermally bonding machinery where the thermal bonding fibers or resins are activated 30. Bonds, or “glue joints” are formed where fibers intersect, the product is cooled and transported from the thermal bonding machinery. Optionally, chemical additives, fire retardant chemicals, or resins may be applied after web or fiber mat formation and before entry into the thermal bonding machinery to provide the desired finished product properties. When the mat of fibers exits the thermal bonding machinery, the product may be slit to the desired width 31, cut to the desired length 32, 33 and packaged for shipment 34.

For non-highloft products, additional processing steps are added after web or fiber mat formation and before thermally bonding. These processing steps may include any of the following processes singularly or in combination to achieve product densification: use of compression rolls (heated or unheated), needling through a needle loom machine 28, stitch bonding 29, hydroentanglement or other densifying processes. Thermal bonding 30 of non-highloft products may be achieved with a thermally bonding oven, calendar or other thermal bonding device. Optionally, chemical additives, fire retardant chemicals, or resins may be applied after web or fiber mat formation and at any point prior to entry into the thermally bonding process machinery to provide for desired finished product properties. When the mat of fibers exits the thermally bonding process, the product may be slit to the desired width, cut to the desired length and packaged for shipment.

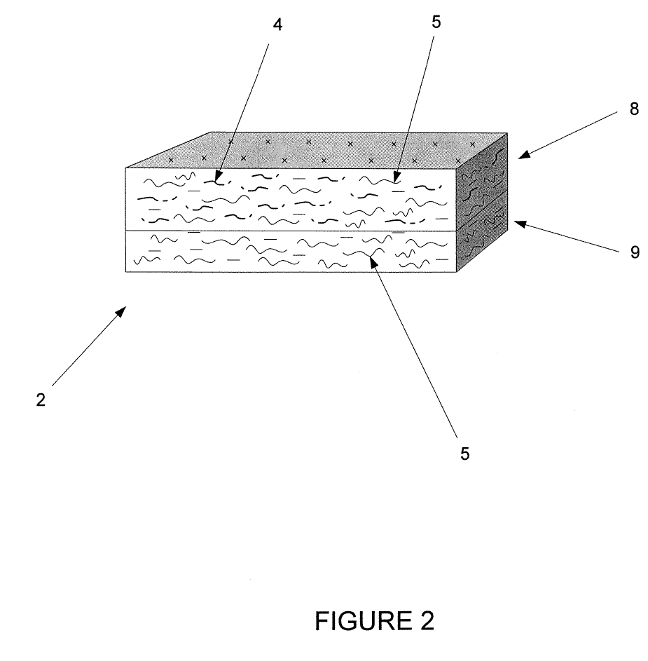

A superior product with decreased cost can be produced in a layered form as seen in FIG. 2, comprising a combination of modacrylic or other category 2 fibers, or category 1 fibers, treated cotton, and low-melt fibers in the top portion 8 of the flame barrier product and treated cotton blended with low-melt fibers in the bottom portion 9 of the product.

The invention will be further described by the following non-limiting examples:

### EXAMPLES

### Example 1

A non-highloft product is produced by placing fibers into hoppers, additionally passing the low melt fiber through a fine opener, electronically weighing the fibers and depositing them on a common conveyor, feeding the various fibers together through a mixing chamber, garnetting, crosslapping, needle punching, thermally bonding, slitting, cutting to length, and packaging by means of techniques known to those of skill in the textile manufacturing industry. The fiber blend consists of the following by weight: 15% polyester/polyester (PET/PET) sheath core binder fiber with the sheath have a 100 degree C. melting point and the core having a 260 degree C. melting temperature (a category 3 fiber); 40% modacrylic fiber (Kaneka Corporation, Japan) (a category 2 fiber); and 45% cotton fiber treated with boric acid for fire resistance (a category 4 fiber). Product thickness is approximately 6 mm, with a basis weight of 300 gm/m². The product demonstrated sufficient flame barrier properties to pass the open flame test of California Technical Bulletin 603 for mattress/boxspring border applications.

### Example 2

A non-highloft product is produced by placing the fibers into hoppers, additionally passing the low melt fiber through a fine opener, electronically weighing the various fibers, depositing the fibers on a common conveyor, feeding the fibers through a mixing chamber, garnetting, crosslapping, needle punching, thermally bonding, slitting, cutting to length, and packaging. The fiber blend consists of the following by weight: 15% polyester/polyester (PET/PET) sheath core binder fiber with the sheath have a 100 degree C. melting point and the core having a 260 degree C. melting temperature; 10% inherently flame-retardant para-aramid fiber (a category 1 fiber); and 75% cotton fiber treated with boric acid for fire resistance. Product thickness is approximately 6 mm with a basis weight of 300 gm/m². This product also meets the requirements for flame barrier material for mattress/boxspring border applications.

### Example 3

A highloft product is produced by placing the fibers into hoppers, additionally passing the low melt fiber through a fine opener, are electronically weighing the various fibers and depositing them on a common conveyor, feeding the fibers through a mixing chamber, garnetting, crosslapping, passing the fibers through a thermal bonding oven, slitting, cutting to length and packaging. The fiber blend consists of the following by weight: 15% polyester/polyester (PET/PET) sheath core binder fiber with the sheath have a 100 degree C. melting point and the core having a 260 degree C. melting temperature; 40% modacrylic fiber; and 45% untreated cotton fiber. Product thickness is approximately 12 mm with a basis weight of 170 gm/m². This product meets the requirements for a flame barrier, and is particularly useful for forming filling of bed clothing products.

The bedding product of the present invention provides a significant improvement in fire retardancy without adding significant manufacturing cost. The inventors have devised a combination of fibers that provides a fire-retardant mattress set that has been shown to meet the requirements of the flammability test of the State of California Department of Consumer Affairs Bureau of Home Furnishings and Thermal Insulation Technical Bulletin 603, dated February 2003 and entitled “Requirements and Test Procedure for Resistance of a Residential Mattress/Box Spring Set to a Large Open-Flame.” When modacrylic is used in the product, the need for fire-retardant chemicals is reduced, producing the desirable effect of limiting exposure of both manufacturing personnel and the consumer to fire-retardant chemicals. Products produced according to the present invention allow the use of existing dress cover and mattress ticking fabrics without modification, so there is no change in the “feel” of the final bedding product.

### Test Results

| Test | | | | |
|---|---|---|---|---|
| # | Mattress | Quilt Barrier | Border Barrier | Result |
| 1 | Two-sided | 610FR 1.5 oz. | 610NFR 1.0 oz. | Failure - |
| | | | | boxspring |
| 3 | Two-sided | 610FR 1.5 oz. | 610NFR 1.0 oz. | Failure - mattress |
| 2 | Two-sided | 610FR 1.5 oz. | 610NFR 1.0 oz. | Pass - |
| | | | w 10% T | extinguished in |
| | | | | 11 minutes |
| 1 | Two-sided | 610FR 1.5 oz. | 610NFR 1.0 oz. | Pass - |
| | | | w 40% M | extinguished in |
| | | | | 2 minutes |
| 5 | Pillow top | 610FR 1.5 oz. | 610NFR 1.0 oz. | Pass - |
| | | | | extinguished in |
| | | | | 5 minutes |
| 6 | Two-sided | 610FR 1.5 oz. | 610NFR 1.0 oz. | Pass at 60 |
| | | | | minutes |

The quilt barriers and border barriers are described as follows:
610 FR 1.5 oz: Material used in the top quilt. The material is not needled, and contains low melt polyester fibers (category 3 fibers), fire-resistant (FR) treated cotton fibers, and may contain a small percentage of miscellaneous polyester fibers (category 5, but no category 1 or 2 fibers).
610 NFR 1.0 oz.: Material used in the border. The material is needled, contains low melt polyester fibers (category 3 fibers), FR treated cotton fibers, and may contain a small percentage of miscellaneous polyester fibers (category 5, but no category 1 or 2 fibers).
610 NFR 1.0 oz. w 10% T: Material used in the border. This material is needled, contains 10% para-aramid Twaron fibers (category 1), low melt polyester fiber (category 3 fibers), FR treated cotton fibers and may contain a small percentage miscellaneous polyester fibers (category 5 fibers).
610 NFR 1.0 oz. w 40% M: Material used in the border. This material is needled, contains 40% modacrylic fibers (category 2), low-melt polyester fibers (category 3 fibers), FR treated cotton fibers, and may contain a small percentage of miscellaneous polyester fibers (category 5 fibers).

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

What is claimed is:

1. A flame barrier product for use in mattresses, foundations, and upholstered furniture comprising a first component which scavenges oxygen from a burn site and a second component which burns to form an insulating char.

2. The barrier of claim 1, wherein the first component comprises at least one category 2 fiber.

3. The barrier of claim 2, wherein the category 2 fiber comprises modacrylic.

4. The barrier of claim 1, wherein the first component comprises a flame-retardant coating.

5. The barrier of claim 1, wherein the second component comprises a batting comprising at least one category 4 fiber.

6. The barrier of claim 5, wherein the category 4 fiber comprises cotton.

7. The barrier of claim 5, wherein the batting is highloft.

8. The barrier of claim 5, wherein the batting is densified.

9. The barrier of claim 6, wherein the cotton is treated with boric acid.

10. A multilayered flame barrier product for use in mattresses, foundations, and upholstered furniture, comprising at least one layer with a first component which scavenges oxygen from a burn site and a second component which burns to form an insulating char.

11. The multilayered barrier of claim 10, wherein the barrier comprises a first layer and a second layer.

12. The multilayered barrier of claim 11, wherein the first layer has a first component comprising at least one category 2 fiber.

13. The multilayered barrier of claim 12, wherein the category 2 fiber comprises modacrylic.

14. The multilayered barrier of claim 11, wherein the first layer has a first component comprising category 1 fibers, treated cotton, or low-melt fibers.

15. The multilayered barrier of claim 12, wherein the first component comprises a flame-retardant coating.

16. The multilayered barrier of claim 12, wherein the first layer has a second component comprising a batting comprising at least one category 4 fiber.

17. The multilayered barrier of claim 16, wherein the category 4 fiber comprises cotton.

18. The multilayered barrier of claim 17, wherein the cotton is treated with boric acid.

19. The multilayered barrier of claim 11, wherein the second layer comprises treated cotton blended with low-melt fiber.

20. A method of forming a flame barrier product from fibers, comprising the steps of:
preparing fibers for processing, wherein the step of preparing fibers for processing comprises the steps of
placing fibers from compressed bales into hoppers or onto a conveyor or other feeder device;
opening the compressed bales;
weighing out specific amounts of fibers;
transporting fibers to a blending chamber;
adding optional additives to the blending chamber; and
blending the fibers with any of said optional additives;
transporting the prepared fibers to one or more processing devices;
forming a fiber web or mat layer from the prepared fibers, wherein the fiber web or mat layer is formed with garnetts, cards, airlaying machines, or volumetric chute-type machines; and
combining the fiber web or mat layer with one or more other fiber web or mat layers formed in substantially the same manner by parallel processes to form a stratified fabric.
